(19) United States
(12) Patent Application Publication
(10) Pub. No.: US 2015/0307822 A1
(43) Pub. Date: Oct. 29, 2015

(54) PROCESS AND EQUIPMENT FOR MULTISTAGE, CONTINUOUS FERMENTATION, WITH FERMENT RECOVERY, REACTIVATION AND RECYCLING, FOR PRODUCING WINES WITH A HIGH ALCOHOL CONTENT

(71) Applicant: CENTRO NACIONAL DE PESQUISA EM ENERGIA MATERIALIS á, Campinas, sp (BR)

(72) Inventors: Carlos Eduardo Vaz ROSSELL, Campinas, Sáo Paulo (BR); Jonas Nolasco JUNIOR, Campinas, Sáo Paulo (BR); Celina Kiyomi YAMAKAWA, Campinas, Sáo Paulo (BR)

(21) Appl. No.: 14/647,000

(22) PCT Filed: Nov. 22, 2013
(86) PCT No.: PCT/BR2013/000505

§ 371 Date: May 22, 2015

(30) Foreign Application Priority Data
Nov. 22, 2012 (BR) 102012029731-0

(51) Int. Cl. C12G 1/022

(52) U.S. Cl. CPC C12G 1/0203

(57) ABSTRACT

Process for producing wines with a high alcohol content, using 4 or 5 fermentation bioreactors, wherein the ferment is recovered, reactivated and recycled by separating the yeast-free wine from the ferment, yeast treatment with acid, separating the cells from the weak water and reactivating the cells by adding nutrients. The fermentation step takes place in an equipment that has a novel design, as well as the separation step.

The present invention relates to a process and equipment for fermentation with high alcoholic content using high concentration and purity wort, preferably based on juice and molasses from sugar cane, with cell recycling, high yield, and productivity. The process address a set of bioreactors for fermentation (BRF) comprising four (4) or five (5) bioreactors, at which will occur the conversion of fermentable sugars to ethanol through biocatalysis by the microorganisms, preferably industrial yeast strains; and a set of bioreactors of biocatalyst reactivation (BRR) comprising one (1) to three (3) bioreactors with agitation and aeration, at which takes place the cell recovery and regeneration steps of the microorganisms before recycling to the alcoholic fermentation process.

### BRIEF DESCRIPTION OF THE PRIOR ART

The advent of encouraging the production of ethanol in Brazil was motivated by the oil crisis in 1973 and 1979, with the creation of the National Program of Alcohol (Proálcool) in 1974 in order to replace petroleum products, such as gasoline, by an alternative and renewable source. This process has begun through the replacement of the gasoline additive MTBE (methyl tertiary butyl ether) of petrochemical source, to anhydrous ethanol, of vegetable source, and subsequently ended with the full replacement of gasoline by hydrated ethanol as fuel.

Currently, ethanol fuel is consumed on a large scale as hydrated ethanol in vehicles powered by ethanol or Flex Fuel vehicles, or as anhydrous ethanol in mandatory blending since 2011, from 18 to 25% of gasoline. The Flex Fuel vehicles generated a significant increase in ethanol consumption in Brazil from 4.3 billion liters in 2003 to 15 billion liters in 2010 (MINISTRY OF DEVELOPMENT, INDUSTRY AND FOREIGN TRADE, 2011).

The leadership of the fuel ethanol international market is the US accounting for 37.2% and Brazil for 35% of world production. In Brazil, this market is worth 40 billion dollars per year and employs over 3.5 million people (VEDA online, 2012).

The Brazilian ethanol is produced by fermentation of sugar cane juice by yeast mostly from the Saccharomyces cerevisiae genre. The alcoholic fermentation in Brazil is characterized by yeast of high cell density, cells recycling, wort formulated with sugar cane juice and molasses, an alcohol content between 8 and 11° GL, temperature between 31 to 38° C., and fermentation cycle time between 8 and 12 hours. The fermentation begins with the wort formulation in a line mixer in which the juice, molasses, and water streams are dosed as a function of concentration of total reducing sugars (TRS) required to obtaining a certain alcoholic titer in the wine. This control is related to the availability of the raw material type and yeast microbiological conditions. For example, if there are more molasses available, the fermentation will hardly exceed 8° GL. Because the TRS concentration would also imply the concentration of salts, which cause an increase in osmotic pressure and therefore lead to inhibition of the yeasts. The prepared wort is fed to the fermentation vats until its filling (fed batch fermentation) or is continuously fed (continuous fermentation). After the conversion of sugars to ethanol, i.e. the fermented wort is sent to centrifugation to recover the yeast of the process in the form of a concentrate cream to reuse in subsequent fermentation cycles. The centrifugation recovers up to 98% of the yeasts in the process. Prior to recycling, the yeast cream is sent to the treatment tanks, which are aerated and agitated cylindrical vessels. Then water and sulfuric acid are added to a pH between 2.0 and 2.5, and are kept stirred and aerated for a period between 1 and 2 hours. It is at this step that it is applied an antibiotic or a product for the bacterial contamination control. After this step, the yeast is sent to a new fermentation cycle. The centrifuged wine, substantially free of yeast, is sent to distillation for recovery, concentration, and dehydration of the ethanol produced.

The configuration of the fermentation process is mostly fed batch fermentation with cell recycling in vessels or conical bottom vats built in epoxy-coated carbon steel. The continuous fermentation units with vessels interconnected in series are less used, in a minority, due to its operation difficulty caused by fluctuations in the raw material processing.

According to Andrietta (2003), the main advantages of the continuous system are higher productivity, lower installation cost, operating stability due to the operation in steady state, easier automation, requires fewer operators, allows better performance of the centrifugal separator, and allows lower consumption of raw materials. Moreover, the author cites that the success of a continuous fermentation unit depends on the process regularly, i.e. which do not suffer fluctuations due to the raw material supply. However, the operational flexibility of an installation would be a key point for the decision making of a new unit, since the sugar and ethanol production mix is strongly determined by the global sugar market, i.e. in a same crop can happen a floating of the production mix. This will result in the process to deal with raw material of good (juice) or low (molasses) quality and also cause variation in the production capacity. Thus, a continuous fermentation unit would not be able to absorb these fluctuations and would compromise the productivity and the revenue.

Andrietta (2003) also reported the evolution of continuous fermentation wherein the first units were assembled from adjustments of the existing infrastructure, which resulted in an inadequacy of the reactors design, incompatibility in the form of supply and distribution of wort. The second generation of continuous fermentation fixed these errors with the use of vessels project and transport phenomena, however lacked a deeper biochemical reaction kinetics. Thereby, the concepts of biochemical engineering were introduced in the third generation, which allowed a safe and stable operation.

Regardless of the configuration, the fermentation process is conducted in the presence of microbial contaminants, bacteria and wild yeasts that compete with the yeast for the substrate process, the sugar. The presence of contaminants in the fermentation process causes the yeast flocculation, reduces the efficiency of centrifuges and the yeast recovery reducing the fermentation yield. Furthermore, some contaminating bacteria are capable of consuming the generated ethanol and the like, causing the death of yeast through the production of toxins excreted in the medium.

Currently, the practice of installations for the contaminants control is the application of chemicals and antibiotics and this is condemned in Europe and some Asian countries, since the intensive use of antibiotics leads to the development of naturally resistance by contaminants. Moreover, the application of these products in the industrial process is carried out in a corrective manner, that is, when the operating losses were already installed. The bacterial contamination is mostly brought by the wort, since it is a medium containing sugar made from sugar cane juice and molasses, and in which there is no practical sterilization for elimination or reduction of contaminating microorganisms. In other words, most part of this contaminant load comes from the own sugar cane. Therefore, there is a need to standardize the raw material for fermentation, wort, in terms of TRS (total reducing sugars), salts concentration, and microbial population in order to minimize fluctuations in the process and avoid losses.

Another factor that contributed to the inhibition of yeast is the product of fermentation itself, the ethanol. The alcohol causes changes in the lipid layer composition of the microorganism membrane, deleterious protein synthesis for the modulation of ion exchange processes, and reduction in glucose transport decreasing the product formation and causing water stress (Hallsworth, 1998 Martini et al., 2004).

Another processes control parameter important in the fermentation is the temperature since the conversion of sugars to ethanol by yeast is an exothermic reaction and proportional to the rate of sugar consumption and ethanol production, i.e. there is heat release and therefore it needs control, often in the range of 31 to 34° C. The temperature control of fermentation is carried out externally by indirect cooling of the wine by cooling water in heat exchangers. This cooling water can come from a closed circuit with evaporative cooling towers or ejectors. In the cooling towers, the outlet temperature is variable due to the performance of the equipment, which depends on the wet bulb temperature of the air at the inlet that can vary significantly during the course of a day and during the harvest. Concurrently, occurs the variation of temperature control that is subject to change above 34° C., a temperature considered high and favourable to the growth of contaminating microorganisms. The situation of high temperature worsens when the fermentation is operated in alcohol content above 8° GL, which accentuates the inhibition of yeast by ethanol. Furthermore, the increased contaminant population, especially Lactobacillus fermentum, induces the phenomenon of yeast flocculation due to protein nature of the waste present on the surface of the L. fermentum that combines to the yeast carbohydrate residues added to the presence of calcium ions (Nishihara and Toraya, 1987).

One way to control the contamination was proposed by Melle-Boinot (1933), acid treatment of yeast or vessel bottom with sulfuric acid between pH 2.0 and 2.5, which aims to work against contamination by Gram-positive bacteria. The pH of the fermentation was maintained between 3.8 and 4.2, whereas Lactobacillus grow at pH near 5.0 (Andrietta et al., 2011).

In the French case originating Melle-Boinot, fed batch with cell recycle, quoted by Nonus and Miniac (1985), the yeast treatment is performed in two steps. In the first step the yeast cream, recovered from the wine after centrifugation on nozzle centrifuge, is sent into a vessel wherein water is added in the same volume ratio to promote the washing of the cells and consequent release of toxins, ethanol and intracellular aliphatic acids and thus make them more active for the next fermentation. The stirring may be performed mechanically or by air sparging and is maintained under these conditions for 1 to 1.5 hours. After that, it is performed a second centrifugation. The yeast cream is discharged into a vat and the light phase, known as tail containing 4° GL, may be recycled in the preparation of wort or sent to distillation. It is not very recommended to recycle this wash water, because it may be a source of contamination and, in the distillation case, will occur the increase of steam consumption. The first wash, besides the purpose of releasing the toxin of yeast, aims mainly dilute the acid to promote a better acid treatment with the reducing of the buffer effect. The second step of the yeast treatment is the dilution of the secondary yeast cream with acidic solution to a pH of 2 and concentration of sulfuric acid between 2 and 2.5 g/L for 1 hour. This second step is effective for bacteria destruction. Mariller (1951) had similarly described the process of treating yeast and added that the advantage of yeast recovery in nozzle centrifuges, or Alfa Laval centrifugal as they are mentioned, is the contamination control by selective centrifugation wherein contaminant microorganisms, due to their size, will go to the wine discharge stream that will be distilled. When comparing the process originating Melle-Boinot with yeast recycle in alcoholic fermentation it is evident that there was an adaptation of the process to that practiced in Brazilian distilleries. The first washing step and the double centrifugation were eliminated from the Brazilian project, in order to reduce capital investment. In contrast, there was the spread of the antibiotics, biocides, and other chemicals application to solve the problem of bacterial contamination. Thus, we see the need for a thorough investigation of the yeast treatment or standing vat for process optimization and representation of this step in kinetic terms for the advancement and application of process control in real time.

On the appropriate design of a reactor, bioreactor, fermenter, or simply fermentation vat, is a set of constructive, mechanical characteristics and capital investment that meet the operational and financial demands compatible to a commodity production. According to Copersucar (1987), a suitable fermenter design is critical to the process because it is the step in which occurs the most important reactions in the process as a whole. In the case of continuous operation fermenters, it is important to have an efficient mixing to prevent the formation of differential zones, which would cause loss of material with a low conversion rate. This type of tank must also decrease the variations caused by the feed stream, since the fluid introduced immediately acquire the characteristics of the medium that is present in the vat, thereby facilitating the control of pH and temperature.

The main feature of the fermenter in current Brazilian facilities is a cylindrical vessel with toriconical bottom and torispherical or curved ceiling built in carbon steel and epoxy coated for ease cleaning and sanitizing. The toriconical bottom is less favorable to homogeneous mixture and promotes the settling of solids, in the case yeast especially when flocculated. Constructively, this geometry has less use of space when compared to torispherical bottom and requires supporting structures. The conical bottom was adopted in fermentation vats projects in order to facilitate the liquid flow, therefore it is a project applied in batch fermentation where there is full discharge of the medium at the end of the reaction. Thus, in case of continuous fermentation, the toriconical bottom would not be justified and would present a disadvantage to promote a homogeneous mixture in some steps of the fermentation.

Still with respect to the information provided by COPERSUCAR (1987), it is known that the foam creates many problems during fermentation. Foams with great stability and elasticity, for example those formed during the juice reaction for the alcohol production, cause the volume loss useful in the vat, filling speed limitation, loss of wine, yeast and wort through overflow. The antifoam used to decrease the amount of foam generates waste, which cause blockages in the system equipment, and also new surfactants which are less aggressive to the centrifugal and metallic surfaces, are expensive, being their use restricted. As described by Venturilli (2008), another way to prevent the formation of foams is the use of new vats with large diameter, and maintaining the speed at which the gas is generated. However, there are disadvantages in the installation in a demand of a greatest area and in the process, with the increased of surface area, which means a greater exposure to air, when there is a low production of carbon dioxide, especially at the beginning and end of fermentation, which results in a deviation in the metabolism of yeasts for microbial reproduction on the basis of aeration.

This way, this overview of the current situation of the alcoholic fermentation technology shows the limitation in processing wine at a concentration of up to 20% in total reducing sugars or 200 g/L, which would represent an ethanol conversion of up to 11° GL. The increased amount of sugars and ethanol would cause a decline in cell maintenance rate and therefore reducing the percentage of cell viability and stopping the fermentation. Because, the ethanol in a high concentration represents a high toxicity to yeasts with impairment of the cell membrane structure in the hydrophobic and hydrophilic proteins and in the endoplasmic reticulum.

However, there is great interest in improving or technological and economic development to enable the said VHG (very high gravity) fermentation or fermentation of high alcohol content of up to 20° GL. An advantage of VHG applied to the alcoholic fermentation process is reducing the circulation of large volumes of water in the process and increasing the productivity of ethanol (ethanol production per reactor volume and time). In view of that, capital investment will be repaid in a shorter time, due to the increase in productivity, affecting directly the dimension reduction of the bioreactors and their interconnections and peripherals. Furthermore, it is expected to obtain yields gains due to the reduction of the ART residual amount entrained with the wine and the amount of residual ethanol entrained in the vinasse. Other advantages related with the VHG is the reduction of the vinasse generation, lower consumption of inputs for the vinasse disposal, and less steam consumption in the wine distillation.

One of the main challenges of the VHG technology applied to fermentation for ethanol production is to maintain the activity and viability of microorganisms over an entire season. This condition is critical for the technological development of a new process for VHG continuous fermentation, since it will provide operational stability of a process at a steady state. It is possible to conclude that the insertion of a cellular strengthening process in the yeast treatment step would control the activity and cell viability maintenance. However, proper investigation is needed to verify those empirical inferences that were based on similarity to the catalytic reactivation process in heterogeneous chemical reactions.

Moreover, it is essential that the process present operational flexibility sized to operate effectively in low and full capacity, having a regular and well-sized heat exchanger system, and, in addition, a wine treatment process to control bacterial contamination in order to standardize the raw material of fermentation to reduce fluctuation in the process.

To the needs above-mentioned and the efforts made to resolve them over the years, prior art for the mentioned process are presented below. The issues that the documents attempt to solve are explained, along with its shortcomings:

Bayrock and Ingledew (2001) tested the VHG (Very High Gravity) fermentation in a continuous process consisting of a set of five (5) bench scale bioreactors, with synthetic medium, all connected in series and controlled at 28° C. with magnetic stirring at 100 rpm. There was sterile air injection in the flow of 2 liters per minute in the first step in order to prevent the return of the wort through the feed pump, to avoid contamination in the feed wort reservoir, and allow the maintenance of the membrane through the synthesis of non-saturated acids and sterols by yeast. The microorganism used is the Saccharomyces cerevisiae yeast and the concentration of glucose in the feed wort was from 15.2 to 31.2%, (w/v). The maximum ethanol concentration obtained was 132 g/L, or about 16.73% (v/v) when fed into the first step with 31.2% (w/v) of glucose. Under this condition, there was a significant decrease in cell viability, below 50%. In this work, we have not explored the cell recycling, and consequently the cell reactivation, and a way to avoid the decrease of live cells percentage.

Alfenore et. al. (2004) investigated an aeration strategy as a determining factor in the performance of high alcohol content fermentation, which resulted in a highly competitive dynamic process. The authors explored the dynamic behavior of yeast in different aeration conditions in high-alcohol content fermentations of up to 147 g/L, (approximately 18° GL) in fed batch processes with Saccharomyces cerevisiae yeast. A 20 L fermenter was used with controlled temperature of 30° C. and pH controlled at 4 with ammonia solution. The settings of the experiments were: complete aeration with air injection in the flow of 100 L/h representing 20% of dissolved oxygen saturation; microaeration where in air was injected in the reactor head at the same rate; and under anaerobic condition without injecting air. The feed wort was prepared from glucose and other chemicals elements required for cell growth. The final concentration of the wort was 700 glucose g/L. The authors used a feeding strategy to maintain a constant glucose concentration in the medium at 100 g/L until reach 90 g/L ethanol, then the feeding was controlled to maintain the glucose concentration at 50 g/L in the medium. This wort feeding strategy was used to minimize cellular osmotic stress due to the high concentration of ethanol. Concomitantly, an exponential type feeding strategy of a vitamin complex containing biotin, pantothenic acid, nicotinic acid, meso-inositol, thiamine, pyridoxine, and para-aminobenzoic acid was used in order to prevent the decline in cell viability due to increased ethanol concentration in the medium. The final amount of cells was approximately 1.32 g/L (dry basis). Under these conditions, the total fermentation time was 45 hours. In the fermentation under aerobic conditions yielded 18.9° GL, 84% of ethanol stoichiometric yield, 4.0 g/L of glycerol final concentration, and 35% of cell viability at the end of fermentation. However, cell viability remained practically from about 90% to 100 g/L of ethanol, happening a sudden drop from 120 g/L. In the fermentation under micro-aerobic conditions was obtained 16.8° GL, 90% of ethanol stoichiometric yield, glycerol final concentration of 12.2 g/L and 42% of cell viability at the end of fermentation. The behavior of cell viability was similar to that previously described. The authors concluded that the maximum growth rate and maximum specific ethanol production rate was obtained aerobically. However, the yield of ethanol on cells was favored in the micro-aeration conditions. In conclusion, it was demonstrated the advantage of the fermentation without oxygen limitation for ethanol production in a fed-batch dynamic process. The aeration strategy and the exponential fed of vitamins showed their importance to maintain a high cell viability to achieve a high final alcohol content. Another advantage of aeration is the ability to manage the formation of glycerol, which was reduced. The disadvantage of this work was the long fermentation time due to the low cell density. This work did not approach the cell recycle.

Another continuous fermentation process tested, this time employed in Brazil, was called Biostil (GB2013716), wherein there is vinasse return from the distillation process to aid in the molasses dilution, thus reducing the volume of such waste a soil contaminant when applied incorrectly and treatment of the wine by centrifugation. The residual product, from the thermal or extractive separation step of ethanol and fermentation liquor, undergoes treatment by pasteurization, sterilization and returns to the fermenter.

The patent IN2012MU01960 uses the Biostil process mentioned above, however the centrifuges are replaced by separator tanks, through the implementation of flocculent yeast strains, which at the end of fermentation are induced to flocculate and then is settled and recovered.

Another process, described in U.S. Pat. No. 4,310,629 uses two separations between yeast cream and wine through centrifuges in which the cream returns to the first and/or second fermenter, with vinasse return from the distillation step to the first fermenter.

This process is not widely used in sugar mills due to operational difficulties in view of the high osmotic pressure of the salts accumulation and low fermentation yield mainly associated with the production of glycerol and cells.

The company ENGENHO NOVO developed a technology of continuous fermentation. According to them, “in the FERCEN process the diluted juice or molasses is continuously fed to one (or more) stirred reactor (s) operating at constant volume, with a pre-defined residence time. Air is periodically added to the fermentation medium while fermented wort is continuously pumped to centrifugal separators, where it is divided into yeast suspension and wine without yeast. The yeast suspension flow is recirculated and may or may not have its pH adjusted before returning to the fermenter. The centrifuged wort without yeast is then sent for the distillation. Again, the most serious problem of this process is that the yeast cream does not undergo refreshment, instead is sent directly to the fermenter having its lifetime reduced and no further reports the temperature control range of the fermentation and the alcohol content range of wine.

The BR8702590 process, describes the recirculation of yeast by direct addition into the fermenter, after its passage through the centrifuges. The feed of the wort and yeast may occur in one or more fermenters in parallel; however, this is not the major focus of the document. The advantage presented is to replace any treatment by the use of pure cream yeast, arising from the first fermentation. The direct recirculation's big problem is the contamination that occurs by the presence of heat-resistant bacteria, which increase at every centrifugation process, because they are not eliminated. Furthermore, the yeast cream after exhaustive use is eventually turned off, due to the presence of natural inhibitors from the fermentation process.

IN2010CH01199 discloses a continuous fermentation in the presence of several tanks, using three (3) centrifugal type separators for separating the yeast from the wine. After this step, the cells are sent to a separator tank and the wine to a decanter. Yeasts drawn from these two tanks will be combined for its recycle. In this system, there is no cell reactivation and the wort and yeast feed occurs in one tank.

Michalski and Wieczorek (1994) used a tower type bioreactor with flocculent yeast operating in fluidized bed, or in the presence of aeration, to produce ethanol. In this case, flocculent yeasts are used because there is no need for a centrifuge, however, the microorganisms are not recovered and reactivated, which decreases its lifetime.

The patent GB2065699 provides a continuous fermentation system having a storage tank in which the mixture is sent to a pasteurization process prior to the addition of water and nutrients. After this treatment, the wort with yeast is sent to the propagation tank where acid, base, antifoam agent and air are added to the system. The mixture is then finally sent to a fermenter with a cold water cooling system, with the addition of these aforementioned chemicals and sterile air (through the presence of a filter). Wine and yeast milk are separated in a separator tank, through flocculation of the microorganism. Part of the yeast is sent to the fermenter tank and the second fermenter tank to increase the results. In this process, the already used yeast does not undergo through refreshment process again, so there is accumulation of inhibitors and contaminants. According to COPERSUCAR (1987), the processes with new yeast addition may lead to external contamination during the initial spread phases for each new cultures loading to the reactor, because they facilitate competition with other microorganisms other than that of interest for the industry.

Another approach with respect to this technique occurs in JP60087783 process where the fermenters in series are turned off when the immobilized yeast has low activity and the other fermenter is bound to continue the process. The yeasts are reactivated and, when the other fermenter has lower yields, the other tank is reconnected.

About the he feeding of nutrients, the file BR8906945 reports its addition to fermenting at different steps, that is, they are evenly distributed. The system comprises fermenters with decanters and internal flow, feed circuit at the base of fermenters and their metering pump, pre-heater and gas recirculation system, at the base of fermenters, with rotameters, foam, pH and temperature regulating devices and a timer. The removal of cellular biomass of the second step is carried out by overflowing, which prevents its industrial application, since the volumes used in the mills renders unfeasible this type of transfer.

As the previous document, the BRPI0905395 patent brings a wort feed system for up to three steps, however being preferably effected in the first step. The differential of this technology is the cooling of the wort, which will feed the fermentation system through chillers absorption. Despite presenting a more efficient cooling system, the document does not bring a reactivation yeast system, applying only acid for the detoxification of the medium, which is not sufficient to maintain the fermentation agent active by satisfactorily long time working in high alcohol content.

The document WO2013082682 has developed a technology for extracting in-situ the inhibitors and ethanol in the fermentation process. For yeast recycle the cells are separated, bled, and treated by stream and subsequently reactivated by nutrients, all in different units. The process, however, does not study new equipments to improve the conventional fermentation process.

The ECOFERM technology developed in partnership whit Dedini and Fermentec companies provides the use of a yeast strain capable of supporting a high alcoholic fermentation process combined with application of cooling technologies and process improvement present in the patent previously cited BRPI0905395.

There is also the application of microorganisms in continuous fermentation. In the patent ES2257206, Schizosaccharomyces pombe is used in the process, in which water is replaced by vinasse from the distillation in the preparation step of the wort. As the microorganism most commonly used in industry, Saccharomyces cerevisiae, does not support high osmotic pressure caused by such substitution, the said microorganism is employed. The steps of this process consists in washing the yeast (wine and milk yeast are separated in centrifuge), acid treatment (concentration of the yeast suspension by second centrifugation and subsequent addition of sulfuric acid to eliminate contamination by bacteria) and inoculation (the inoculum preparation is done in one fermenter with aeration).

In the document BR8607244 is described a process in which two fermenters alternating each other receive the vinasse arising from a distiller, while one provides wine for distillation the other is turned off, after this first process is finished the second fermenter is brought into action. In this case, the yeast cream is recycled to the fermenters however; it does not undergo any treatment or reactivation in specific bioreactors, since everything takes place in the fermenter. The contamination control occurs through the high osmotic pressure caused by the substitution of water by vinasse. Again, the microorganism employed is the Schizosaccharomyces pombe.

In both cases, the yeast used is not widely applied in industry. The addition of acid and nutrients is also not performed in specific bioreactors, in the first document, acid is mixed with yeast suspension in a centrifuge, and for the second it occurs in the fermenter itself.

It can be seen as the prior art, according to the document PI9106024, a continuous fermentation process, which cools the medium by direct injection of water from sterile process and recycles the cells by means of a centrifuge which are rinsed with sterile filtered water. The process is not applicable directly to ethanol production and does not use Saccharomyces cerevisiae as an example of the main application.

In the document US2002155583, a process of microaeration by traditional agitators and/or aeration tanks used in continuous fermentation is described. The process, however, claims the flocculating system for yeasts, which are recovered by decantation.

The process PI0014789 brings a tank for the formation and growth of yeast with microaeration by compressed air present in the bottom of the tank and recirculation of yeasts that can be reactivated with the addition of nutrients and/or bactericidal agents. However, the major focus of the invention is the shape of the tank to be used. With a cylindrical body, concave top and conical bottom, the model has features such as removal of process foam and feedback stream control. The same is parallel to the fermentation system. In the description, there are no details about the reactivation system of the yeasts, nor about the later steps to the formation and growth of the microorganism.

In addition, as prior art, the patent GB2199844 can be mentioned, which presents a continuous fermentation system with stirring through the CO₂ releasing itself, from the first to the last reactor.

The US20120220003 process describes a separation process of the organic products of interest, through constant withdrawal of fermentation products and their transfer to a flash chamber, which works under vacuum. The organic products are collected by evaporation of water and others, especially water, are concentrated and recycled to the fermenter. The microorganisms, due to their sensitivity to the process, are previously separated by ultrafiltration. Note that the microorganisms are directly recycled to the fermenter and, according to the text the process is intended mainly for the fermentation of sugarcane molasses, which tends to produce biobutanol.

The deposit U.S. Pat. No. 5,426,024 presents a fermenter and fermentation processes improvement for growing processes or microorganism propagation and/or production of metabolites from microorganisms, especially for high cell density processes. They are particularly focused on aerobic fermentation with air control, at high conditions, into the fermenter. The mechanical design of the fermenter has bottom and top torispherical. The main purpose of the new design is the control of foam formation, however, does not claim the use of anaerobic fermentation processes such as alcoholic fermentation.

Many studies mention the supplementation of nutrients during fermentation, for example, Ingledew and Jones (1994) reviewed the supplementation of nitrogen from different sources during fermentation with high alcohol content of wheat wort with employment of Saccharomyces cerevisiae yeast. The sources of nitrogen are yeast extract, Fermaid K, Pharmamedia, (NH₄)₂HPO₄, (NH₄)₂SO₄, urea, Yeastex-61 and Yeastex-82. The fermentation experiments were conducted after saccharification with glucoamylase at 30° C. After 30 minutes, the temperature was reduced to 20° C. and followed by the inoculation of the microorganism. The result of the effect of nitrogen supplementation was observed to decrease the fermentation time compared to fermentation without supplementation. The presence of 1% yeast extract, Fermaid K 1-2%, and urea 16 mM reduced the fermentation time from 9 hours to 4 hours and produced a wine of approximately 20° GL.

Therefore, the search of prior art for alcoholic fermentation showed a citation of a continuous process of fermentation for the production of wines with high alcohol content covering a particular step of yeast treatment considering a reactivation of cellular activity. Further, a thorough approach of mechanical and hydraulic configuration of the bioreactors and the control strategy of the temperature of fermentation to optimize the total time of the fermentation cycle and also to minimize the inhibitory effect by the high concentration of ethanol. Thus, this way, the effort made is justified for the technological development of a process and equipment for multistep continuous fermentation with yeast recovery, reactivation, and recycle to obtain wines with high alcohol content.

A prior art drawback is that there is no feed on two or more bioreactors to improve the conversion of sugars to ethanol, distribution of thermal load, and stirring the carbon dioxide release.

A prior art drawback is that there are not two steps of cell separation in different units aimed to remove inhibitors, reduce the buffer effect, and improve the acid treatment and cellular reactivation.

### SUMMARY OF THE INVENTION

The “PROCESS AND EQUIPMENT FOR MULTISTAGE, CONTINUOUS FERMENTATION, WITH FERMENT RECOVERY, REACTIVATION, AND RECYCLING, FOR PRODUCING WINES WITH A HIGH ALCOHOL CONTENT” refers to a complete process and equipment for high alcohol content fermentation using high concentration and purity wort in sugars preferably based on the juice and molasses from sugar cane with cell recycling, high yield and high productivity. The process comprises a set of bioreactors for fermentation (BRF) comprised of 4 (four) or 5 (five) bioreactors, in which will occur the conversion of fermentable sugars to ethanol through biocatalysis by microorganisms, preferably strains of industrial yeast; a set of biocatalyst reactivation bioreactors (BRR) consisted of 1 (one) to 3 (three) bioreactors with agitation and aeration, wherein will happen the recovery step and cell regeneration of microorganisms before recycling to the fermentation process. The bioreactors are designed under sanitary standards to ensure low level of contaminants dispensing the intensive use of antibiotics, and fluid dynamics analysis for mechanical and transfer design that promote a solid-liquid-gas homogeneous mixture.

The wort Formulation (1) and the wort Treatment (2) comprise setting the amounts of different raw materials (juice, syrup, final honey, or molasses and other sources of fermentable sugars) for the fermentation, polishing, and thermal treatment step of the wort. These steps aim the standardization in physical, chemical, and microbiological terms to minimize fluctuations in the quality of the raw material and/or changing on the mix production of the sugar mills. The wort formulation will be operated depending on the availability of raw materials, preferably sugar cane juice and molasses, and, furthermore, depending on the preset final alcoholic grade.

After the Formulation (1), the wort is clarified with the aid of clarifying agents, polymers, and a suitable heating to promote the removal of organic acids, alkali and alkaline earth salts, suspended materials, colloids, microorganisms and contaminants spores. Preferably, after that, the wort is concentrated in an evaporator and sent to the thermal treatment process for the microbiological standardization of the medium. The wort thermal treatment will be performed by high temperature sterilization in a short period of time, called HTST technology (High Temperature, Short Time), a more advantageous technology for the reduction/elimination and control of bacterial contaminants, particularly thermo-resistant microorganisms.

The multistage continuous fermentation (3) comprises the fermentation itself in a specific set of bioreactors connected in series in which the standardized wort is fed continuously and controlled in order to maintain the availability of sugar distributed in all the steps. Each bioreactor is a fermentation step, whereas the first two steps are called bioreactor of production and the other steps of depletion. The temperature control will be performed strategically depending on the sugars to ethanol conversion rate at each step, e.g., the temperature will be higher in steps in which there is a large quantity of sugars and less ethanol for the purpose of accelerating the reaction kinetics. However, in the steps of less sugars amount and high ethanol concentration the temperature is reduced to minimize the severity of the process by the ethanol and to maintain a high cell viability.

The Separation (4) and Cells treatment (5) are essential for sustaining the high alcohol content fermentation process during the entire harvest. The Separation step (4) of the yeast from the wine is carried out in equipment called nozzle centrifuge to promote also selective centrifugation, in which the bacteria, due to their size, will pass through the nozzles and be entrained along with the wine to be distillate. The Cells treatment step (5) includes acid treatment, second centrifugation, and cellular reactivation. The acid treatment starts when the yeast cream originating from the first centrifugation is sent to the specific bioreactor in which receive water in the same volume proportion of cream and acid is added, preferably sulfuric or nitric acid, to promote cell dispersion or deflocculation. This condition is kept stirred (mechanically or by sterile compressed air added directly) for a period of up to 2 hours. Thereafter, takes place a second centrifugation to remove this wash water, which has a low pH and contains alcohols and acids.

The yeast cream is discharged at a specific bioreactor for cell reinvigoration or cell regeneration. This process consists of a metabolic acclimatization by the addition of nutrients (sucrose, ammonium salts, diphosphate or sulfate salts, urea, or complex formulations such as industrial preparation of amino acids, protein hydrolysates, or yeast extract) under stirring and aerobic conditions to promote restoration and maintenance of cell membrane and also induce the microbial growth in one of the two yeast generations. The Cells treatment (5) is essential in the claimed process since the percentage of viable cells in each cell recycle is preserved by catalytic reactivation conditions to keep metabolically active.

### BRIEF DESCRIPTION OF THE DRAWINGS

FIG. 1—overall block diagram of the continuous fermentation.

FIG. 2—detailed block diagram of the cell regeneration.

FIG. 3—block diagram of the feeding process of the bioreactors.

FIG. 4—Front view of the bioreactors of the continuous fermentation process in multistep.

FIG. 5—Top view of the bioreactors of the continuous fermentation process in multistep.

### DETAILED DESCRIPTION OF THE INVENTION

FIG. 1 shows the overall block diagram of the novel fermentation process claimed. First, the wort Formulation (1) is made from various fermentable carbon sources including sugarcane juice obtained directly from juice extraction section, juice treatment or evaporation, syrup, final honey of higher or lesser degree of exhaustion or molasses from the sugar mill itself or third parties; hydrolysate liquors from lignocellulosic materials among other materials available, for example, from sweet sorghum, beet and corn. At this step, the formulation of the wort aims to establish the amount of total reducing sugars ART/° Brix and standardize it so that there are no significant fluctuations in the alcoholic fermentation in terms of conversion rates in the first three steps.

Next, the wort treatment step (2) is initiated, which consists of the physical, chemical and microbiological treatment to remove suspended solids and drastically reduce the charge of contaminants. Clarifying agents are added, preferably phosphoric acid and lime, to cause agglutination of the particulate materials, colloids, microorganisms and contaminants spores and other suspended matter. After this preparation, there is a heating to the boiling point at atmospheric pressure and it is maintained for a short period of time, up to 30 minutes. This heating is accomplished in shell and tube heat exchangers, or at a plate, or in a mixing tank with direct or indirect heating. Then, the wort is sent to the decanters, equipment widely used in juice treatment process in the sugar industry, wherein surfactant material is added, preferably non-ionic polymer, to drag the bonded or flocculated materials and thereby clarifying the wort. During this process, the entrainment of organic acids, alkali, and alkaline earth salts takes place, which are undesirable in the high alcohol content fermentation process. The retention time in the decanter is from 0.5 h to 3.0 h according to the type of decanter used.

After the physical-chemical treatment, there is preferably a concentration through Roberts, TASTE, Falling Film, scraped surface or other type evaporators commonly employed in the sugar industry. At this step the concentration of ART will be finely adjusted according to the defined operational parameters; the operating range is between 80 and 400 g ART/L.

To finish the wort treatment step, a thermal treatment is performed with heating at high temperature between 121° C. and 135° C., for a retention time less than 180 seconds. A drawback from the application of UHTST thermal treatment could be the degradation of sugars, producing inhibitory components. However, Nolasco (2012) studied the thermal treatment in sugar cane juice and molasses to produce ethanol in a pilot plant of continuous sterilization and found that the properties of the sugars are retained at temperatures of 125° C., 130° C. and 135° C. and thus it was proved that the fermentability of these medium was maintained due to the conservation of sugars and nutrients.

The process parameters at the end of the wort treatment step (2) are: dextran reduction above 75%; elimination of insoluble solids higher than 95%; softening of calcium and magnesium ions of 50%; increased purity of the wort of up to 0.7%; Lactobacillus sp contaminant of less than 10 CFU/mL; contaminating by spores of G. stearothermophilus spores of less than 10² spores/mL.

After the steps (1) and (2), the standardized wort is continuously fed to the Fermentation (3). The benefits of a standardized wort feed in an fed-batch or continuous industrial process are: improvement in the control of the sugars consumption rate and in the temperature control; elimination of oscillation caused by bacterial contamination and by increased medium osmotic pressure; elimination of the variation of wine alcohol content and other products such as glycerol and higher alcohols. Due to these improvements, there is less fluctuation in process control parameters in the distillation of wine, productivity and fermentation yield.

In the first two steps of fermentation (3), the temperature control range in the bioreactors is from 30° C. to 30° C. corresponding to temperatures in which favor the kinetics rate of the biochemical reaction without prejudice to the microorganisms. In the two other steps, agitation will be mechanical with combination of ascending and axial flow to keep the mixture and temperatures homogeneous in the range of 30 to 26° C., comparatively lower than the initial steps in order to minimize the toxic effect due to the increase of alcohol content in the medium. In the last step, the temperature is maintained between 26° C. and 28° C. At this step, the air is injected to promote microaeration to minimize damage to the cell membrane and consequently minimize the rate of cell death due to the high alcohol content. This last step aims the final exhaustion of the sugars that are at low concentration. The temperature control and the microaeration in the final step of fermentation are essential in that the high alcohol content above 11° GL avoids irreversible damage to cells. Therefore, as raising the alcohol content of the wine while passing successively through the first to the last step, there is a reduction of temperature control and inclusion of mitigating actions to maintain cell viability.

The first fermentation Bioreactor (3) which comprises the first step called conversion bioreactor is characterized by operating with cell in the range of 40 to 95 g/L, preferably 80 g/L, ethanol concentration in the range of 40 to 75 g/L, preferably 67 g/L, ART concentration in the range of 70 to 120 g/L, preferably 76 g/L, sugars to ethanol conversion in the range of 15 to 60%, preferably 30%, yield in the range of 6 to 20 g/L·h, preferably 18 g/L·h, residence time in the range of 1.5 to 5 hours, preferably 2.8 hours.

The second fermentation Bioreactor (3) which comprises the second step also called the conversion bioreactor is characterized by operating with cells in the range of 30 to 75 g/L, preferably 56 g/L, ethanol concentration in the range of 80 to 95 g/L, preferably 90 g/L, ART concentration in the range of 30 to 75 g/L, preferably 68 g/L, sugars to ethanol conversion in the range of 15 to 45%, preferably 42%, yield in the range of 5 to 25 g/L·h, preferably 8.5 g/L·h, residence time in the range of 1.5 to 4.5 hours, preferably 2.7 hours.

The third fermentation Bioreactor (3) which comprises the third step called depletion bioreactor is characterized by operating with cells in the range of 30 to 65 g/L, preferably 57 g/L, ethanol concentration in the range 85 to 115 g/L, preferably 110 g/L, ART concentration in the range of 10 to 70 g/L, preferably 23 g/L, sugars to ethanol conversion in the range of 10 to 35%, preferably 18%, yield in the range of 2.5 to 10 g/L·h, preferably 7.4 g/L·h, residence time in the range of 1.5 to 4.0 hours, preferably 2.7 hours.

The forth fermentation Bioreactor (3) comprising the fourth step also called depletion bioreactor is characterized by operating with cells in the range of 30 to 65 g/L, preferably 57 g/L, ethanol concentration in the range of 100 to 120 g/L, preferably 120 g/L, ART concentration in the range of 3 to 30 g/L, preferably 2.85 g/L, ethanol to sugars conversion in the range of 5 to 15%, preferably 8%, productivity in the range of 3.0 to 9.0 g/L·h, preferably 3.3 g/L·h, residence time in the range of 1.5 to 3.5 hours, preferably 2.7 hours.

The fifth fermentation Bioreactor (3) comprising the fifth step also called depletion bioreactor is characterized by operating with cells in the range of 30 to 65 g/L, preferably 57 g/L, ethanol concentration in the range of 115 to 125 g/L, preferably 120 g/L ART, concentration in the range of 0.2 to 10 g/L, preferably 0.3 g/L, sugars to ethanol conversion in the range of 1 to 8%, preferably 1%, yield in the range of 0.5 to 5.5 g/L·h, preferably 0.8 g/L·h, the residence time from 1.0 to 2.5 hours, preferably 1.5 hours.

The execution of the fermentation process controls (3) and cells treatment (5) will be carried out by applying analytical capabilities of real-time monitoring by online sensors or by periodic sampling to provide data, mainly concentration of sugars and ethanol. Once these data are available, it is applied a mathematical model to be used as a simulator to simplify the development and implementation of new controllers and optimizers and thus allow the re-tuning of existing controllers and the determination of new optimum conditions of operation when there are operational changes. The mathematical model of continuous fermentation unit considers mass and energy balances for the components of the reaction mixture and also the energy balance of the thermal exchange system, as well as the kinetic rate whose parameters have temperature and microorganism strain employed dependence.

The Fermentation (3) has productivity between 7.0 and 8.5 kg/m³·h, fermentation yield between 89 and 91%, total residence time from 12 to 20 hours, and vinasse generation of 50% at source, when compared to the current process of alcoholic fermentation. The final wine is characterized by containing residual sugar or non-fermentable sugar below 0.50 g/L and ethanol in the range of 10 to 15° GL.

The wine generated in fermentation step (3) is pumped into Cell separation (4), wherein the wine without yeast is sent to the distillation and the yeast that will be recycled is sent to the Cells treatment step (5).

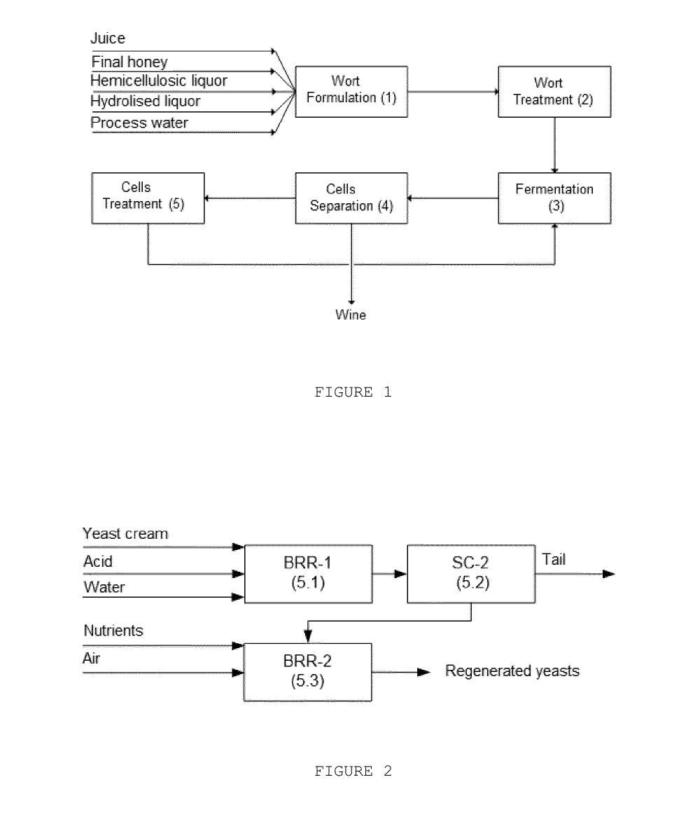

FIG. 2 shows the block diagram in detail of the step (5) shown in FIG. 1. Note that each step occurs in a specific type of bioreactor. Thus, the description of the process follows:

The cell-treatment unit receives yeast suspension and wine, which will be separated in the separation step SC-1 (4), thus wine is sent to the distillation columns and the cells are sent to acid treatment, preferably with sulfuric or phosphoric acid, and process water in BRR-1 (5.1) with pH range from 2.0 to 3.0 and temperature from 26° C. to 36° C. The acid treatment time is a function of the flocculation state of the yeast, the more flocculated the greater the residence time. However, that time does not exceed two hours so they do not cause damage to the cells due to low pH and do not reduce the process productivity. Then the cells are recovered again in SC-2 (5.2) with nozzle centrifuges and begins the process of cellular reactivity or cellular strengthening in BRR-2 (5.3) with the addition of nutrients such as carbon, nitrogen and potassium sources, complex formulations as industrial preparations of ammonium, protein hydrolysates, yeast extract and injection of sterile air.

The lighter portion of the second centrifugation, called weak water, contains ethanol, acids, and other metabolite products and can be reused as process water after suitable treatment.

The effectiveness of this cell treatment step (5), shown in FIG. 1 and FIG. 2, is monitored through the performance of Fermentation (3) by the alcohol content of end wine, productivity, death rate of the yeast, enzyme activity, and percentage of viable cells. The cells treatment (5) is critical in the fermentation process of high alcohol content with cell recycle to ensure the maintenance of activity and cell vitality throughout the season.

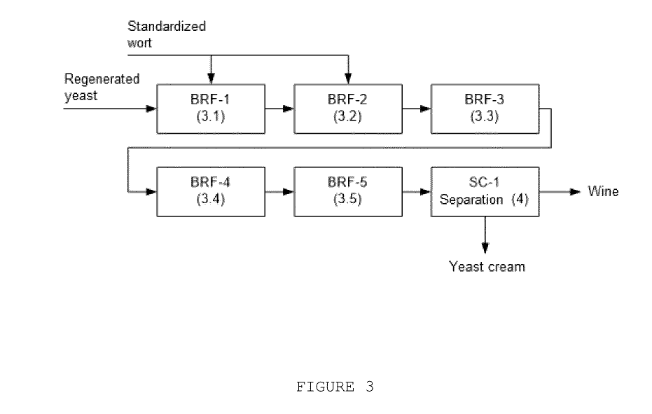

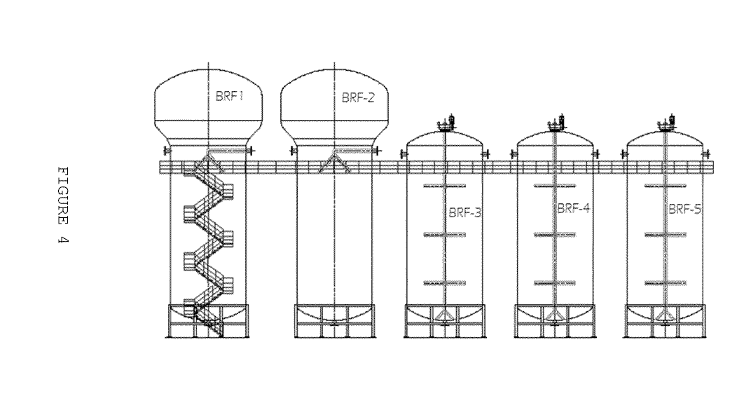

FIG. 3 illustrates a detailed block diagram of continuous fermentation in which the BRF-1 (3.1), BRF-2 (3.2), BRF-3 (3.3), BRF-4 (3.4), and BRF-5 (3.5) denotations represent the bioreactors connected in series and each bioreactor is a fermentation step. BRF-1, BRF-2, BRF-3, and BRF-4 have the same main volumetric capacity and BRF-5 has a lower capacity than the others do.

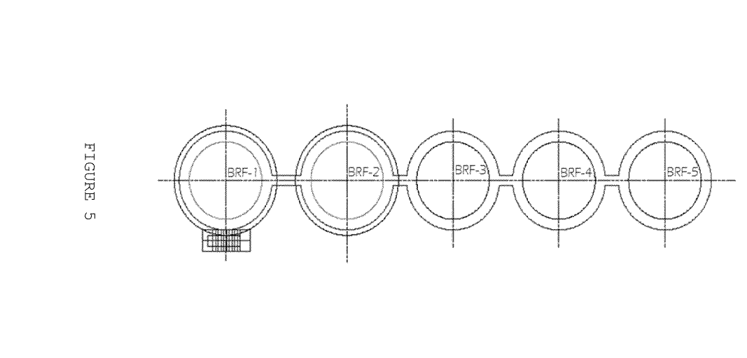

FIG. 4 shows constructive project of the bioreactors set for the alcoholic fermentation process proposed. The BRF-1 (3.1) and BRF-2 (3.2) bioreactors are made of stainless steel under sanitary standard, with minimal internal surface finishing corresponding to Grana 180, and have a different top design, torispherical bottom-head and torispherical or semi-spherical top-head, with the aim of promoting a better distribution of fed wort and break the surface tension of the foam, typically generated in alcoholic fermentation from sugarcane juice or molasses. The standardized wort is fed in the two steps while, after cell reactivation, the yeasts return to the first step or BRF-1 (3.1).

The interconnection of the bioreactors, the centrifugal separators, and other peripheral equipment such as pipes, valves, pumps, and heat exchangers, is of sanitary standard to prevent and minimize contaminants proliferation conditions. FIG. 5 shows the top view of the bioreactors set.

The bioreactors BRF-1 (3.1) and BRF-2 (3.2) have approximate aspect ratio of 4:1 (height:diameter), the mixture is entirely provided by the liquid dispersion at discharge pressure of the recirculation pump generating the circulation of vessel contents and keeps in suspension of the microorganisms due to the drag forces exerted by the rising liquid. In the upper part, there is a mechanical expansion to promote the reduction of the upward velocity of the fluid and, thereby, separate the gaseous phase from the liquid phase. This solution presents a simple mechanical configuration and reduced operating costs based on lower energy requirements, which allowed a constructive and operational optimization as it enables the control of foaming and floated yeast accumulation tendency. Consequently, there is a reduction in the antifoaming application, reducing the operating cost.

BRF-3 (3.3), BRF-4 (3.4), and BRF-5 (3.5) are made of stainless steel under sanitary standard with minimum inner surface finishing corresponding to the Grana 180. The mechanical characteristics are vertical cylindrical pressure vessel with torispherical or cambered bottom and top, in accordance with current mechanical standards.

BRF-5 (3.5) has the same mechanical characteristics as the previous steps BRF-3 (3.3) and BRF-4 (3.4), except for lower volumetric capacity, approximately 50% smaller than the previous step volume, which is justified by majority conversion of sugars with medium enrichment in ethanol and depletion of the gases, i.e., there is a reduction of the apparent bulk density and decrease of the medium due to the loss of carbon as carbon dioxide.

The cooling in all steps of Fermentation (3) and Cells treatment (5) will be via reaction medium recirculation with aid of axial centrifugal pump in the flow corresponding to the total time of 1 to 2 hours, in heat exchangers plates installed externally to the bioreactors or possibly in shell and tube heat exchanger or of a specific design of spiral heat exchanger. The suction of the reaction medium by the pump is at the top and the discharge will be done at the bottom to prevent sedimentation of flocculated yeast and also the selectivity of yeasts.

1. A process for multistage continuous fermentation with ferment recovery, recycling and reactivation to produce wines with a high alcohol content, wherein the fermentation takes place in 4 or 5 bioreactors, preferably 5 bioreactors, in which in the first bioreactor the cell concentration is from 40 to 95 g/L, preferably 80 g/L, the ethanol concentration is from 40 to 75 g/L, preferably 67 g/L, the temperature is from 36 to 30° C., and the residence time is from 1.5 to 5 hours, preferably 2.8 hours; in the second bioreactor the cell concentration is from 30 to 75 g/L, preferably 56 g/L, the ethanol concentration is from 80 to 95 g/L, preferably 90 g/L, the temperature is from 36 to 30° C., and the residence time is from 1.5 to 4.5 hours, preferably 2.7 hours; in the third bioreactor the cell concentration is from 30 to 65 g/L, preferably 57 g/L, the ethanol concentration is from 85 to 115 g/L, preferably 110 g/L, the temperature is from 30 to 26° C., and the residence time is from 1.5 to 4.0 hours, preferably 2.7 hours; in the fourth bioreactor the cell concentration is from 30 to 65 g/L, preferably 57 g/L, the ethanol concentration is from 100 to 120 g/L, preferably 120 g/L, the temperature is from 30° C. to 26° C., and the residence time is from 1.5 to 3.5 hours, preferably 2.7 hours; in the fifth bioreactor the cell concentration is from 30 to 65 g/L, preferably 57 g/L, the ethanol concentration is from 115 from 125 g/L, preferably 120 g/L, the temperature is from 26° C. to 28° C., and the residence time is from 1.0 to 2.5 hours, preferably 1.5 hours.

2. The process according to claim 1, wherein, before fermentation occurs the wort formulation comprises adjusting the amount of total reducing sugars ART/° Brix, deriving from raw materials rich in fermentable sugars, preferably juice or molasses of sugarcane.

3. The process according to claim 1, wherein after the formulation of the wort, the treatment of said wort takes place, said treatment comprising
i) adding clarifying agents, preferably phosphoric acid and lime
ii) heating to the boiling point at atmospheric pressure for 30 minutes
iii) adding surfactant material for decantation, wherein said surfactant material is preferably non-ionic polymer
iv) concentration of the wort to 80 to 400 ART g/L, preferably by evaporation
v) thermal treatment of the wort at a temperature of 121° C. to 135° C. for 180 seconds.

4. The process according to claim 1, wherein after the fermentation of the wort, the following steps occur:
i) separation of ferment-free wine and yeast
ii) acid treatment of yeast, comprising addition of water and acid, preferably sulfuric or phosphoric acid, to reach a pH range between 2.0 and 3.0, at a temperature of 26° C. to 30° C. for up to 2 hr
iii) separating the yeast cells from the weak water, preferably by centrifugation
iv) cell reactivation via sterile air injection and addition of nutrients, preferably sources of carbon, nitrogen, and potassium.

5. The process according to claim 1, which contains a recirculating cooling system with the aid of the axial centrifugal pump with flow corresponding to the total volume, for 1 to 2 hours.

6. The process according to claim 1, wherein the weak water from step iii) of separation be reused in the wort formulation step or distillation, and the yeast of step iv) of separation return to the first bioreactor.

7. The process according to claim 1, comprising:
i) the temperature control in each bioreactor occurs through acquisition and deployment of real-time data of ethanol, total reducing sugars, alcohols and organic acids concentration
ii) the cell viability control occurs through data acquisition in real-time of metabolic activity of the microorganisms
iii) the re-tuning of controllers and optimizers occurs via process simulators.

8. An equipment for multistage continuous fermentation with ferment recovery, reactivation and recycle to obtain wines with a high alcohol content, it which contains BRF-1 and BRF-2 bioreactors, of top with torispherical top-head with mechanical and expansion and torispherical or semi-spherical bottom-head, BRF-3, BRF-4 and BRF-5; SC-1 separator; acid treatment bioreactor BRR-1; nozzle centrifuge SC-2; and cell reactivation bioreactor BRR-2.

9. An equipment for multistage continuous fermentation with ferment recovery, reactivation and recycling to obtain wines with a high alcohol content, it which contains BRF-1 and BRF-2 bioreactors, of top with torispherical top-head with mechanical and expansion and torispherical or semi-spherical bottom-head, BRF-3, BRF-4 and BRF-5; SC-1 separator; acidic bioreactor treatment BRR-1; disc centrifuge SC-2; and cell reactivation bioreactor BRR-2.

10. The equipment according to claim 8 or 9, wherein BRR-1 and BRR-2 comprises stirring and aeration.

11. The equipment for multistage continuous fermentation with ferment recovery, recycling, and reactivation to obtain wines with a high alcohol content, according to claim 9, wherein BRF-5 contains compressed air injection and has low volumetric capacity, preferably volumetric capacity lower than 50%.

12. The process according to claim 1, wherein the wort fermentation step occurs in the Bioreactors BRF-1 to BRF-4 or BRF-1 to BRF-5, and the separation step occurs in SC-1, BRR-1, SC-2, and BRR-2.
